(19) United States
(12) Patent Application Publication
(10) Pub. No.: US 2022/0379987 A1
(43) Pub. Date: Dec. 1, 2022

(54) Bicycle Frame Sealing Means

(71) Applicant: Canyon Bicycles GmbH, Koblenz (DE)

(72) Inventors: Nils Sommer, Bonn (DE); Vincenz Thoma, Obermaiselstein (DE)

(21) Appl. No.: 17/827,048

(22) Filed: May 27, 2022

(30) Foreign Application Priority Data
May 31, 2021 (DE) 20 2021 102 958.7

(51) Int. Cl. B62J 1/08

(52) U.S. Cl. CPC B62J 1/08

(57) ABSTRACT

A bicycle frame sealing means includes a frame-side sealing element adapted to be sealingly connected with a saddle tube of a bicycle frame. A saddle post-side sealing element is adapted to be sealingly connected with a saddle post. Both sealing elements are interconnected by means of a flexible connecting elements, so that relative movements can occur between the two sealing elements or between the saddle tube and the saddle post, while a good tightness is still ensured.

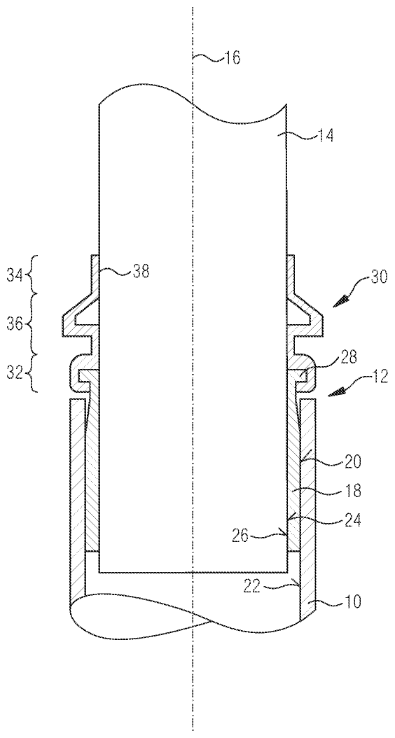

### CROSS-REFERENCE TO RELATED APPLICATIONS

This application claims priority to German Patent Application No. 20 2021 102 958.7 filed May 31, 2021, the disclosure of which is hereby incorporated by reference in its entirety.

### BACKGROUND OF THE DISCLOSURE

The disclosure relates to a bicycle frame sealing means.

### DESCRIPTION OF RELATED ART

Bicycle frames have a seat tube or saddle tube connected with the saddle post supporting the saddle. Typically, the saddle tube has an opening at its upper side, into which the saddle post is inserted. Fixing is usually effected using a clamping element, for example a clamp surrounding the saddle tube. Other clamping means are known, for example clamping means using a grubber screw provided at the saddle tube. Relative movements between the saddle post and the saddle tube occur when loads are applied. Over time, these relative movements cause abrasion between the saddle post and the saddle tube. The ingress of dirt particles in this region accelerates the occurring abrasion many times over. Significant damage to the saddle tube and/or the saddle post can be caused thereby. In addition, water may enter in this region causing lubricants to be washed away.

For preventing the ingress of dirt particles or dirty water, it is known to provide seals in this region. For example, it is known to arrange an annular element, such as an insert, between the saddle tube and the saddle post, which element has a sealing lip in contact with the saddle post. Further, it is known to arrange rubber rings as a seal between the saddle tube and the saddle post. Due to the large relative movement occurring in practice between the saddle post and the saddle tube, however, the sealing effect of known seals is rather bad, so that the damages caused by abrasion are still rather substantial. In particular with non-round, aerodynamically optimized tube profiles, the sealing effect of known seals is very bad.

### SUMMARY OF THE DISCLOSURE

It is an object of the disclosure to provide a bicycle frame sealing means with which the sealing between the saddle tube and the saddle post is improved.

The object is achieved with a bicycle frame sealing means having the features of claim 1.

The bicycle frame sealing means of the disclosure has a frame-side sealing element which may be connected with the saddle tube of a bicycle frame in a sealing manner. Here, the connection of the frame-side sealing element with the saddle tube may be made either directly or indirectly. Further, the bicycle frame sealing means of the disclosure comprises a saddle-side sealing element. The saddle-side sealing element is the sealing element directed towards the saddle. This sealing element is sealingly connected with a saddle post, i.e. the tube element supporting the saddle. Here, it is again possible to realize a direct or an indirect connection.

According to the disclosure, the two sealing elements are connected with each other through a flexible connecting element. As is essential to the disclosure, the two sealing elements can thus be connected respectively on the frame-side and the saddle-side with the saddle tube and the saddle post, either directly or indirectly. Here, it is possible to realize a strong and thus tight connection. By connecting the two sealing elements using a flexible connecting element, relative movements occurring between the two sealing elements can be compensated. Therefore, relative movements between the two sealing elements or relative movements between the saddle tube and the saddle post do not affect the sealing effect, since relative movements are possible because of the flexible connecting element. In particular, the flexible connecting element of the disclosure provides for a decoupling of the two sealing elements, so that these may respectively follow the movement of the corresponding contact partner, i.e. the saddle tube and the saddle post, respectively. According to the disclosure, it is therefore advantageous in particular that, specifically, no relative movements occur between the sealing surfaces of the sealing elements and those of the contact partners. Relative movements thus do not cause, for example, a separation of sealing surfaces in contact with each other and thus cause no leaks.

According to the disclosure, a decoupling is effected such that relative movements between the saddle tube and the saddle post, or the sealing elements connected with the same, are allowable, or the occurrence of such relative movements does not result in a leak, since the saddle tube is decoupled from the saddle post with respect to the sealing element. Thus, no or only extremely small relative movements occur at sealing surfaces. The sealing effect is very much improved thereby.

In particular, it is possible that the connecting element is connected with the frame-side and/or the saddle post-side sealing element in a sealing manner, in particular firmly. A firm connection is possible, since the flexibility can be realized by the connecting element itself. It is particularly preferred that the connecting element is formed as a bellows.

The frame-side or the saddle post-side sealing element is preferably annular. In particular, the sealing elements thus surround the saddle tube or the saddle post all around in the manner of a ring, with the ring having e.g. an oval, circular or another shape, depending on the geometry. An annular design in particular allows to shape the sealing element such that is in contact with a circumferential sealing surface. Since, according to the disclosure, no or only small relative movements occur in this region, a very good sealing can be achieved.

Preferably, an in particular annularly extending bead is connected with the saddle tube. Again, the connection may be made either directly or indirectly, the bead being formed e.g. by an intermediate element. Likewise, the bead may be integrated directly in the saddle tube and may in particular be formed integrally with the same. In a preferred embodiment, the frame-side sealing element engages around the bead. In particular with an annularly extending bead, which is also engaged annularly, a very good connection between the bead and the frame-side sealing element is possible. Due to the undercut formed by the bead, a very good sealing effect can be realized.

The frame-side sealing element is preferably connected with the saddle tube via an intermediate element. This intermediate element may comprise the in particular circumferentially extending bead. Further, it is preferred that the intermediate element is formed to be rotationally symmetric. In particular, the intermediate element has a cylindrical protrusion which, in the mounted state, extends into the saddle tube. Thus, for mounting, the intermediate element can be inserted into the frame tube, and the saddle post is then inserted into the intermediate element. In particular, this has the advantage that the bicycle frame sealing means of the disclosure can be retrofitted in a simple manner, since no structural change of the saddle tube is required.

In a particularly preferred embodiment, also the connecting element is formed to be rotationally symmetric or annular.

As an alternative, in particular with aerodynamically designed saddle tubes and saddle posts, the bicycle frame sealing means of the disclosure also has a corresponding aerodynamic shape. The shape of the bicycle frame sealing means preferably corresponds to the shape of the contour of the saddle tube and/or the saddle post.

In a preferred development of the bicycle frame sealing means, the saddle post-side sealing element has an inner surface formed complementary to an outer surface of the saddle post. The improvement of the sealing effect is ensured by the fact that the two surfaces are in surface contact and thus in sealing contact with each other in the mounted state. Corresponding sealing surfaces may also be provided between the frame-side sealing element and the saddle tube.

In a further preferred development of the bicycle frame sealing means of the disclosure, recesses for receiving sealant or lubricant may be provided in the frame-side sealing element and/or the saddle post-side sealing element and or the connecting element. The tightness can be further improved thereby, and in particular the occurrence of noise caused by relative movements can be avoided. In particular for the enhancement of the sealing effect, the recesses may particularly be designed as circumferential grooves.

In addition, it is possible that the connecting element has at least one pressure compensation opening. This is at least one opening with a preferably very small diameter. Thereby, it is ensured that a corresponding pressure compensation is not effected via the sealing surfaces.

Moreover, the disclosure relates to a bicycle frame system. The bicycle frame system comprises a bicycle frame with a saddle tube. Further, the bicycle frame can comprise a top tube and/or a down tube. Depending on the design of the bicycle frame, the same may comprise a rear frame or be hingedly connected with a rear frame. Here, the design of the bicycle frame may include different known geometries. A saddle post is connected with the saddle tube of the bicycle frame by insertion. For sealing, a bicycle frame sealing means arranged between the saddle tube and the saddle post, as described above.

### BRIEF DESCRIPTION OF THE DRAWINGS

The disclosure will be explained in more detail hereinafter with reference to a preferred embodiment and to the accompanying drawing:

The FIGURE is a schematic sectional view of a preferred embodiment of a bicycle frame sealing means of the present disclosure.

### DETAILED DESCRIPTION

The FIGURE schematically illustrates an upper end of a saddle tube 10 of a bicycle frame. The bicycle frame typically comprises a top tube connected with the saddle tube 10, as well as a downtube. Further, a steer tube for receiving a front wheel fork may be a part of the bicycle frame, and a bottom bracket seat may also be a part of the bicycle frame. Further, a rear frame may be connected rigidly or hingedly with the bicycle frame, the rear frame typically comprising chain stays and seat stays.

Relevant to the disclosure is the saddle tube 10 with an opening 12 substantially directed upward. A saddle post 14 is arranged in the opening 12, which is connected with a saddle or supports a saddle at its upper end not illustrated in the FIGURE. The end of the saddle post 14, which is the lower end in the FIGURE, is arranged in the saddle tube 10. The saddle post 14 is typically clampingly fixed in the saddle tube 10 by a clamping means not illustrated. A simple type of clamping means is a clamp surrounding the saddle tube 10. It is also possible to arrange e.g. a grubber screw for clamping in the saddle tube 10, which acts on a clamping means arranged e.g. below the saddle tube 10 and thus clampingly fixes the saddle post 14 in the saddle tube 10.

In the embodiment illustrated, an intermediate element 18 is arranged in the opening 12 of the saddle tube 10, the intermediate element being in particular formed to be rotationally symmetric to a longitudinal axis 16. An aerodynamically optimized outer contour is also possible. The intermediate element 18 has an outer side 20 that is complementary to an inner side 22 of the saddle tube 10, so that the outer side 20 of the intermediate element 18 Is in surface contact with, preferably bonded to the inner side 22 of the saddle tube 10. The saddle tube may also have an unround contour, such as an oval contour, the intermediate element having the corresponding contour in this case. This also applies to the cross section of the saddle post 14.

The saddle post 14 is inserted into the intermediate element 18, so that again an outer side 24 of the saddle post 14 is in surface contact with an inner side 26 of the intermediate element 18.

The intermediate element 18 has a circumferential bead 28 at the end arranged outside the saddle tube 10. In the embodiment illustrated, the bicycle frame sealing means 20 is connected with the bead 28 of the intermediate element 18. As an alternative, the bicycle frame sealing means 30 could also be connected directly with the saddle tube 10.

The bicycle frame sealing means 30 has a frame-side sealing element 32, as well as a saddle post-side sealing element 34. The two sealing elements are interconnected through a connecting element 36. In the embodiment illustrated, the two sealing elements 32, 34, as well as the connecting element 36 are formed integrally. In the embodiment illustrated, the frame-side sealing element 32 is fixedly connected with the intermediate element 18. The connection is made via the bead 28 around which the frame-side sealing element 32 engages. Thereby, a very tight connection is realized between the frame-side sealing element 32 and the intermediate element 18.

In the embodiment illustrated, the saddle post-side sealing element 34 is annular in shape and surrounds the saddle post 14. Here, an inner side 38 of the saddle post-side sealing element 34 is in surface contact with the outer side 24 of the saddle post 14. Again, a firm connection can be made, e.g. by frictional engagement, so that this region also has a high tightness. In addition, for example metal ring, a clamping ring or the like may be provided which enhances the sealing effect.

According to the disclosure, the two sealing elements 32, 34, which are fixedly connected with the intermediate element 18 and the saddle post 14, are flexibly connected with each other via a connecting element 36. The connecting element 36, which is may be made e.g. of a softer elastic plastic material and/or may have a lower density, serves to provide a tighter connection of the two sealing elements 32, 34, on the one hand, and provides a flexible connection, on the other hand. Thereby, it is ensured that relative movements occurring between the two sealing elements 32, 34 do not cause a decrease in tightness, since the two sealing elements are only connected in a flexible manner, but not in a rigid or fixed manner. Since relative movements between the two sealing elements 32, 34 are possible without affecting the tightness, even relative movements occurring between the saddle tube 10 and the saddle post 14 will not cause movements between the sealing elements 32, 34 and their contact partners 10, 14. Thereby, sealing is ensured also in the case of relative movements between the saddle post 14 and the saddle tube 10.

Further, sealants or lubricants may be provided in non-illustrated recesses of the sealing elements 32 and/or 34 and/or the connecting element 36. In addition, the connecting element may preferably have pressure compensating openings not illustrated.

The components illustrated in the FIGURE as rotationally symmetric with respect to the axis 16 may also have other geometries, while it is always relevant that the corresponding sealing surfaces are in sealing contact with each other and the geometries are formed complementary to each other. Further, the intermediate element 18 may also be omitted. In this case, the frame-side sealing element 32 is, for example, connected with the saddle tube 10 using a clamping element, the sealing element in particular being put over the opening 12 of the saddle tube 10. For example, the frame-side sealing element 32 can be bonded to an outer side of the saddle tube 10.

What is claimed is:

1. A bicycle frame sealing means comprising
a frame-side sealing element adapted to be connected with a saddle tube of a bicycle frame in a sealing manner,
a saddle post-side sealing element adapted to be connected with a saddle post in a sealing manner, and
a flexible connecting element arranged between the two sealing elements.

2. The bicycle frame sealing means according to claim 1, wherein the connecting element is sealingly connected with the frame-side and/or the saddle post-side sealing element.

3. The bicycle frame sealing means according to claim 1, wherein the frame-side and/or saddle post-side sealing element are annular in shape.

4. The bicycle frame sealing means according to claim 1, further comprising an annular bead connected with the saddle tube, around which bead the frame-side sealing element engages.

5. The bicycle frame sealing means according to claim 1, wherein the frame-side sealing element is connected with the saddle tube via an intermediate element.

6. The bicycle frame sealing means according to claim 5, wherein the intermediate element comprises a cylindrical protrusion protruding into the saddle tube when in the mounted state.

7. The bicycle frame sealing means according to claim 5, wherein the bead is arranged on the intermediate element.

8. The bicycle frame sealing means according to claim 1, wherein the intermediate element is annular in shape.

9. The bicycle frame sealing means according to claim 1, wherein the connecting element is formed as bellows.

10. The bicycle frame sealing means according to claim 1, wherein the saddle post-side sealing element has an inner surface formed complementary to an outer surface of the saddle post so that the two surfaces are in sealing contact with each other when in the mounted state.

11. The bicycle frame sealing means according to claim 1, wherein recesses for holding sealant are formed in the frame-side sealing element and/or in the saddle post-side sealing element and/or in the connecting element.

12. The bicycle frame sealing means according to claim 11, wherein the recesses are at least in part formed as circumferential groove.

13. The bicycle frame sealing means claim 1, wherein the connecting element has at least one pressure compensation opening.

14. A bicycle frame system comprising a bicycle frame with a saddle tube, a saddle post inserted into the saddle tube, and a bicycle frame sealing means according to claim 1 arranged between the saddle tube and the saddle post.

15. The bicycle frame sealing means according to claim 1, wherein the connecting element is sealingly and fixidly connected with the frame-side and/or the saddle post-side sealing element.

16. The bicycle frame sealing means according to claim 5, wherein the intermediate element comprises a circular cylindrical protrusion protruding into the saddle tube when in the mounted state.
